(19) United States
(12) Patent Application Publication
(10) Pub. No.: US 2024/0193791 A1
(43) Pub. Date: Jun. 13, 2024

(54) TECHNIQUES FOR ACCELERATING OPTICAL FLOW COMPUTATIONS

(71) Applicant: Meta Platforms Technologies, LLC, Menlo Park, CA (US)

(72) Inventors: Andrey Tovchigrechko, SARATOGA, CA (US); David Vakrat, Kfar Saba (IL); Olivier Francois Joseph Harel, Mountain View, CA (US)

(21) Appl. No.: 18/533,916

(22) Filed: Dec. 8, 2023

Related U.S. Application Data
(60) Provisional application No. 63/387,263, filed on Dec. 13, 2022.

(51) Int. Cl. G06T 7/20

(52) U.S. Cl. CPC G06T 7/20

(57) ABSTRACT

A method for generating an optical flow for a plurality of successive image frames includes executing an initialization process by performing a plurality of raster scans of a patch of pixels in one or more of the plurality of successive image frames in parallel. The plurality of raster scans of the patch of pixels includes a plurality of optical flow estimates between the plurality of successive image frames. The method includes executing a propagation process based on the plurality of optical flow estimates between the plurality of successive image frames. Executing the propagation process includes propagating the plurality of optical flow estimates for one or more neighboring pixels associated with the patch of pixels. The method includes executing a search process by identifying one or more offsets based on the plurality of optical flow estimates for the one or more neighboring pixels associated with the patch of pixels.

### PRIORITY

This application claims the benefit under 35 U.S.C. § 119(c) of U.S. Provisional Patent Application No. 63/387,263, filed 13 Dec. 2022, which is incorporated herein by reference.

### TECHNICAL FIELD

This disclosure relates generally to optical flow computations, and, more specifically, to techniques for accelerating optical flow computations.

### BACKGROUND

Optical flow computation, which may include a two-dimensional (2D) displacement indicating the apparent motion of brightness patterns between two successive images, provides valuable information about the spatial arrangement of displayed image objects and the change rate of the spatial arrangement of displayed image objects. Generally, optical flow is widely used in applications, such as visual surveillance tasks, image segmentation, action recognition, object detection, image sequence super-resolution, and augmented reality (AR) and virtual reality (VR) applications, to name a few. In some instances, optical flow computations may be very expensive in terms of processing and memory resources of a computing device on which the optical flow computations are performed. Thus, to reduce the memory while maintaining high performance, a PatchMatch algorithm may be applied in many optical flow computations and applications. For example, the PatchMatch algorithm may include a fast randomized algorithm for finding approximate nearest neighbors on densely sampled patches of pixels. However, the PatchMatch algorithm may itself consume considerable processing and memory resources of computing devices.

### SUMMARY OF CERTAIN EMBODIMENTS

The present embodiments are directed to techniques for accelerating and efficiently generating optical flow computations for a number of successive image frames by providing an accelerated and efficient PatchMatch algorithm. In certain embodiments, a computing device may access image data corresponding to a plurality of successive image frames to be displayed on a display associated with a computing device. For example, in some embodiments, the computing device may access the image data corresponding to the plurality of successive image frames by accessing one or more two-dimensional (2D) arrays of pixels corresponding to the plurality of successive image frames. In certain embodiments, the computing device may generate an optical flow to represent pixel displacements from a first image frame of the plurality of successive image frames to a second image frame of the plurality of successive image frames.

In certain embodiments, the computing device may generate the optical flow for the plurality of successive image frames by executing an initialization process by performing a plurality of raster scans of a patch of pixels in one or more of the plurality of successive image frames in parallel. For example, in one embodiment, the plurality of raster scans of the patch of pixels may include a plurality of optical flow estimates between the plurality of successive image frames. In certain embodiments, the computing device may generate the optical flow for the plurality of successive image frames by executing a propagation process based on the plurality of optical flow estimates between the plurality of successive image frames. For example, in one embodiment, executing the propagation process may include propagating the plurality of optical flow estimates for one or more neighboring pixels associated with the patch of pixels.

In certain embodiments, the computing device may execute the propagation process by executing the propagation process based on the plurality of optical flow estimates and in accordance with one or more predetermined metrics. In certain embodiments, the computing device may perform the plurality of raster scans of the patch of pixels by performing a plurality of raster scans in a same vertical raster scan direction or in different horizontal raster scan directions. In one embodiment, the one or more predetermined metrics may include one or more of a data metric, a rigidity metric, or a constraint metric. In certain embodiments, the computing device may generate the optical flow for the plurality of successive image frames by executing a search process by identifying one or more offsets based at least in part on the plurality of optical flow estimates for the one or more neighboring pixels associated with the patch of pixels.

In certain embodiments, the computing device may generate the optical flow for the plurality of successive image frames by performing a filtering and a scaling of the optical flow. In certain embodiments, the computing device may further generate the optical flow for the plurality of successive image frames by comparing the generated optical flow to a reference optical flow, and generating one or more confidence metrics based on the comparison of the generated optical flow and the reference optical flow. In one embodiment, the one or more confidence metrics may include a measure of a consistency between the generated optical flow and the reference optical flow.

The embodiments disclosed herein are only examples, and the scope of this disclosure is not limited to them. Certain embodiments may include all, some, or none of the components, elements, features, functions, operations, or steps of the embodiments disclosed above. Embodiments according to the invention are in particular disclosed in the attached claims directed to a method, a storage medium, a system and a computer program product, wherein any feature mentioned in one claim category, e.g., method, can be claimed in another claim category, e.g., system, as well. The dependencies or references back in the attached claims are chosen for formal reasons only. However, any subject matter resulting from a deliberate reference back to any previous claims (in particular multiple dependencies) can be claimed as well, so that any combination of claims and the features thereof are disclosed and can be claimed regardless of the dependencies chosen in the attached claims. The subject-matter which can be claimed comprises not only the combinations of features as set out in the attached claims but also any other combination of features in the claims, wherein each feature mentioned in the claims can be combined with any other feature or combination of other features in the claims. Furthermore, any of the embodiments and features described or depicted herein can be claimed in a separate claim and/or in any combination with any embodiment or feature described or depicted herein or with any of the features of the attached claims.

### BRIEF DESCRIPTION OF THE DRAWINGS

FIG. 1A illustrates an example extended reality (XR) system.

FIG. 1B illustrates another example extended reality (XR) system.

FIGS. 2A and 2B illustrate an optical flow computation architecture.

FIGS. 3A and 3B illustrate example embodiments of a single raster scan diagram and a dual raster scan diagram, respectively.

FIGS. 4A and 4B illustrate example embodiments of a margin filtering around boundaries diagram and a marginal filtering including four-input flow group filter diagram, respectively.

FIGS. 5A-5D illustrate example embodiments of a median smoothing filtering diagram, a warp ordering filtering diagram, another warp ordering filtering diagram, and a warp ordering filtering correction diagram, respectively.

FIG. 6 is a flow diagram of a method for accelerating and efficiently generating optical flow computations for a number of successive image frames.

FIG. 7 illustrates an example computer system.

### DESCRIPTION OF EXAMPLE EMBODIMENTS

Optical flow computation, which may include a two-dimensional (2D) displacement indicating the apparent motion of brightness patterns between two successive images, provides valuable information about the spatial arrangement of displayed image objects and the change rate of the spatial arrangement of displayed image objects. Generally, optical flow is widely used in applications, such as visual surveillance tasks, image segmentation, action recognition, object detection, image sequence super-resolution, and augmented reality (AR) and virtual reality (VR) applications, to name a few. In some instances, optical flow computations may be very expensive in terms of processing and memory resources of a computing device on which the optical flow computations are performed. Thus, to reduce the memory while maintaining high performance, a PatchMatch algorithm may be applied in many optical flow computations and applications. For example, the PatchMatch algorithm may include a fast randomized algorithm for finding approximate nearest neighbors on densely sampled patches of pixels. However, the PatchMatch algorithm may itself consume considerable processing and memory resources of computing devices.

Accordingly, the present embodiments are directed to techniques for accelerating and efficiently generating optical flow computations for a number of successive image frames by providing an accelerated and efficient PatchMatch algorithm. In certain embodiments, a computing device may access image data corresponding to a plurality of successive image frames to be displayed on a display associated with a computing device. For example, in some embodiments, the computing device may access the image data corresponding to the plurality of successive image frames by accessing one or more two-dimensional (2D) arrays of pixels corresponding to the plurality of successive image frames. In certain embodiments, the computing device may generate an optical flow to represent pixel displacements from a first image frame of the plurality of successive image frames to a second image frame of the plurality of successive image frames.

In certain embodiments, the computing device may generate the optical flow for the plurality of successive image frames by executing an initialization process by performing a plurality of raster scans of a patch of pixels in one or more of the plurality of successive image frames in parallel. For example, in one embodiment, the plurality of raster scans of the patch of pixels may include a plurality of optical flow estimates between the plurality of successive image frames. In certain embodiments, the computing device may generate the optical flow for the plurality of successive image frames by executing a propagation process based on the plurality of optical flow estimates between the plurality of successive image frames. For example, in one embodiment, executing the propagation process may include propagating the plurality of optical flow estimates for one or more neighboring pixels associated with the patch of pixels.

In certain embodiments, the computing device may execute the propagation process by executing the propagation process based on the plurality of optical flow estimates and in accordance with one or more predetermined metrics. In certain embodiments, the computing device may perform the plurality of raster scans of the patch of pixels by performing a plurality of raster scans in a same vertical raster scan direction or in different horizontal raster scan directions. In one embodiment, the one or more predetermined metrics may include one or more of a data metric, a rigidity metric, or a constraint metric. In certain embodiments, the computing device may generate the optical flow for the plurality of successive image frames by executing a search process by identifying one or more offsets based at least in part on the plurality of optical flow estimates for the one or more neighboring pixels associated with the patch of pixels.

In certain embodiments, the computing device may generate the optical flow for the plurality of successive image frames by performing a filtering and a scaling of the optical flow. In certain embodiments, the computing device may further generate the optical flow for the plurality of successive image frames by comparing the generated optical flow to a reference optical flow, and generating one or more confidence metrics based on the comparison of the generated optical flow and the reference optical flow. In one embodiment, the one or more confidence metrics may include a measure of a consistency between the generated optical flow and the reference optical flow. In this way, the present techniques for accelerating and efficiently generating optical flow computations for a number of successive image frames by providing an accelerated and efficient PatchMatch algorithm may reduce the memory resources, processing resources, and the processing times of computing devices otherwise suitable for executing PatchMatch algorithms and computing optical flow.

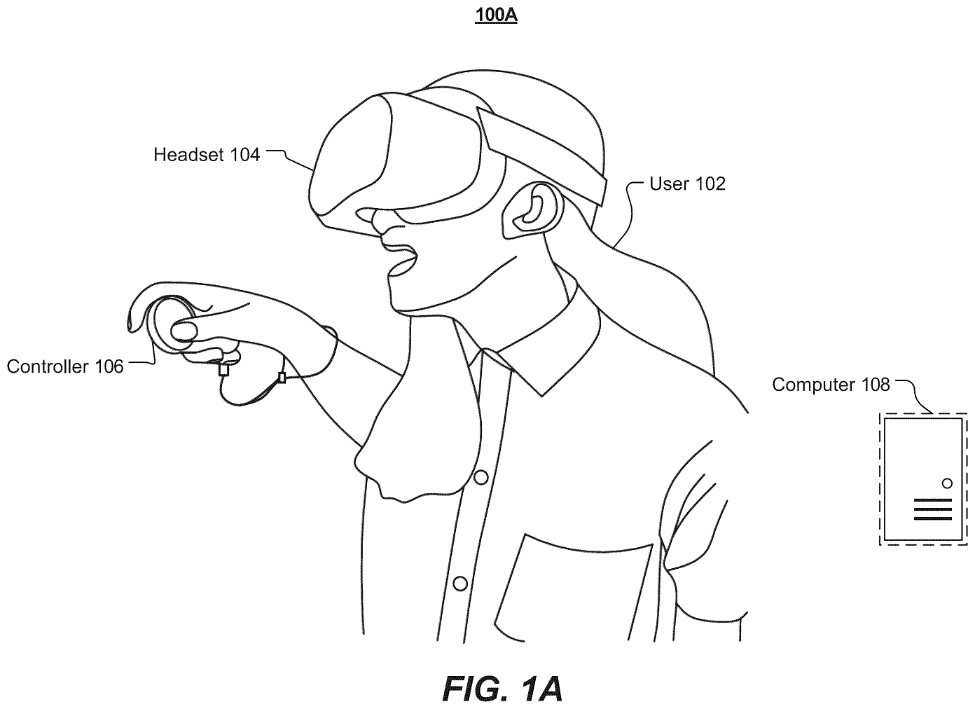

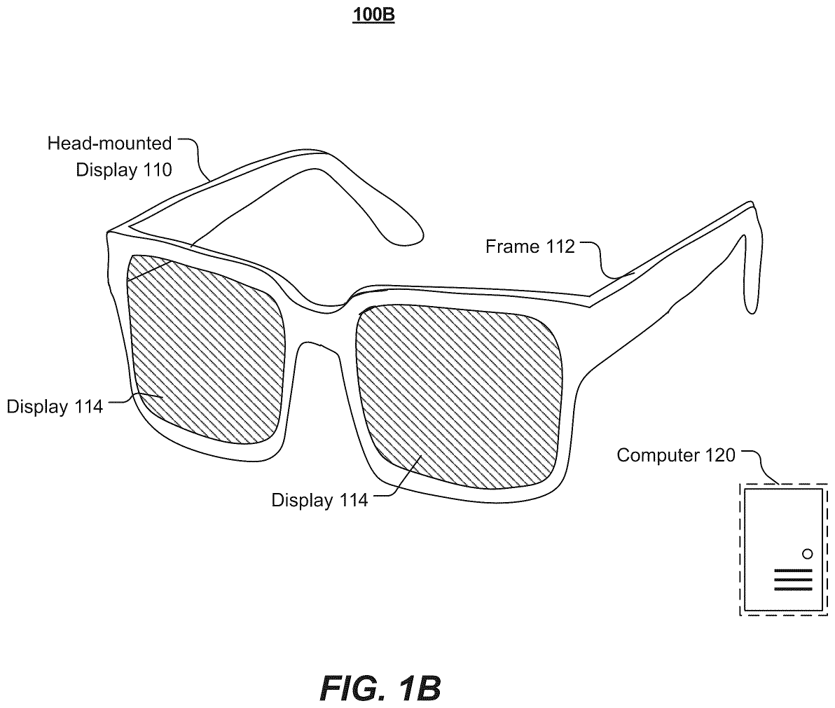

FIG. 1A illustrates an example extended reality (XR) system 100A, in accordance with the presently disclosed embodiments. In certain embodiments, the XR system 100A may include, for example, a virtual-reality (VR) system, an augmented-reality (AR) system, a mixed-reality (MR) system, and/or other similar XR system. In certain embodiments, the XR system 100A may include a headset 104, a controller 106, and a computing system 108. A user 102 may wear the headset 104 that may display visual XR content to the user 102. The headset 104 may include an audio device that may provide audio XR content to the user 102. The headset 104 may include one or more cameras which can capture images and videos of environments. The headset 104 may include an eye tracking system to determine the vergence distance of the user 102. The headset 104 may be referred as a head-mounted display (HDM).

In certain embodiments, the controller 106 may include a trackpad and one or more buttons. The controller 106 may receive inputs from the user 102 and relay the inputs to the computing system 108. The controller 106 may also provide haptic feedback to the user 102. The computing system 108 may be connected to the headset 104 and the controller 106 through cables or wireless connections. The computing system 108 may control the headset 104 and the controller 106 to provide the XR content to and receive inputs from the user 102. The computing system 108 may be a standalone host computer system, an on-board computer system integrated with the headset 104, a mobile device, or any other hardware platform capable of providing XR content to and receiving inputs from the user 102.

FIG. 1B illustrates an example XR system 100B, in accordance with the presently disclosed embodiments. The XR system 100B may include a head-mounted display (HMD) 110 (e.g., glasses) including a frame 112, one or more displays 114, and a computing system 120. The displays 114 may be transparent or translucent allowing a user wearing the HMD 110 to look through the displays 114 to see the real world and displaying visual XR content to the user at the same time. The HMD 110 may include an audio device that may provide audio XR content to users. The HMD 110 may include one or more cameras which can capture images and videos of environments. The HMD 110 may include an eye tracking system to track the vergence movement of the user wearing the HMD 110.

In certain embodiments, the XR system 100B may further include a controller 106 including a trackpad and one or more buttons. The controller 106 may receive inputs from users and relay the inputs to the computing system 120. The controller 106 may also provide haptic feedback to users. The computing system 120 may be connected to the HMD 110 and the controller through cables or wireless connections. The computing system 120 may control the HMD 110 and the controller 106 to provide the XR content to and receive inputs from users. The computing system 120 may be a standalone host computer system, an on-board computer system integrated with the HMD 110, a mobile device, or any other hardware platform capable of providing XR content to and receiving inputs from users.

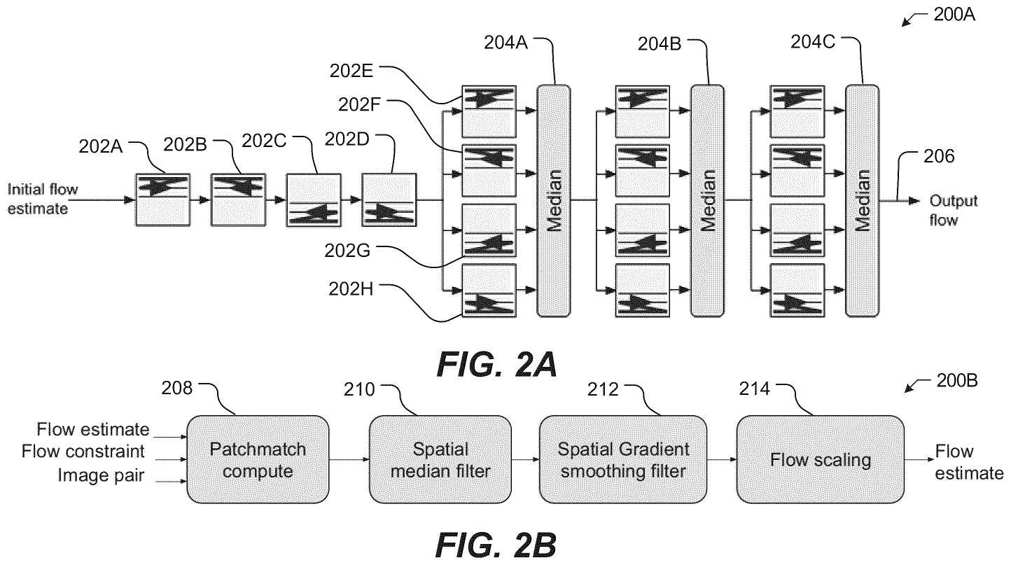

FIGS. 2A and 2B illustrate an optical flow computation architecture 200A, 200B, in accordance with the presently disclosed embodiments. In one embodiment, optical flow computation architecture 200A, 200B may be included within the HMD 110, the computing system 108, and/or the computing system 120 as discussed above with respect to FIGS. 1A and 1B. Further, it should be appreciated, the optical flow computation architecture 200A, 200B may include different illustrations of the same architecture (e.g., same functionally and computationally). As depicted by FIGS. 2A and 2B, the optical flow computation architecture 200A, 200B may be utilized to implement an accelerated and efficient PatchMatch algorithm for computing optical flow in accordance with the presently disclosed embodiments.

Specifically, the optical flow computation architecture 200A may leverage the optical flow field of neighboring flow vectors to guide the optical flow search at a given vector and update vectors sequentially (e.g., top left to bottom right horizontal raster scan, top right to bottom left horizontal raster scan, bottom right to top left horizontal raster scan, bottom right to top left horizontal raster scan). As discussed herein, an optical flow (e.g., optical flow 206) may include a two-dimensional (2D) vector, which may include coordinate components X and Y and/or displacement components dX and dY. The values taken by (dX, dY) may be referred to as offsets.

In certain embodiments, the optical flow computation architecture 200A, 200B may execute for each vector an initialization process, a propagation process, and a searching process. In one embodiment, the optical flow computation architecture 200A, 200B may perform the initialization process by performing a number of raster scans 202A, 202B, 202C, and 202D, which may each be chained in a serial manner and passed to one or more median filters 204A, 204B, and 204C. In another embodiment, the optical flow computation architecture 200A, 200B may perform the initialization process by performing a number of raster scans 202E, 202F, 202G, and 202H, which may be performed in a parallel manner and passed to the one or more median filters 204A, 204B, and 204C. For example, in some embodiments, the number of raster scans 202A, 202B, 202C, and 202D chained and performed serially may result in more outliers as compared to the number of raster scans 202E, 202F, 202G, and 202H performed in parallel.

In certain embodiments, the number of raster scans 202E, 202F, 202G, and 202H performed in parallel may compute a smoother optical flow 206 and reduce outliers. In one embodiment, the optical flow computation architecture 200A may utilize an N-bit (e.g., 4-bit, 8-bit, 16-bit) brightness for template matching utilizing the accelerated and efficient PatchMatch algorithm. In certain embodiments, the template matching metric may include, for example, a data metric, rigidity, and a constraint metric. In one embodiment, the data metric may include a sum of absolute differences (SAD), which includes three possible patch sizes (e.g., 3×3 pixels, 5×5 pixels, 7×7 pixels, and so forth). In one embodiment, with respect to the rigidity metric, for a given raster scan order, the optical flow computation architecture 200A may penalize optical flow 206 estimates that deviate from the previously updated horizontal and vertical neighbors.

For example, the rigidity metric may add a smoothness term (e.g., TV-LI optical flow estimation term) as part of the accelerated and efficient PatchMatch algorithm as disclosed herein. In certain embodiments, with respect to the constraint metric, based on an estimate of the sparse optical flow, the optical flow computation architecture 200A may utilize the estimate of the sparse optical flow to bias the matching process. In certain embodiments, the optical flow computation architecture 200A, 200B may then calculate dense optical flow 206 around the sparse points, which may include known displacement values.

In certain embodiments, the optical flow computation architecture 200A, 200B may further include a compute engine 208 for implementing the accelerated and efficient PatchMatch algorithm as disclosed herein. For example, in one embodiment, the compute engine 208 of the optical flow computation architecture 200A, 200B may execute either one raster scan or a pair of raster scans with the same vertical raster direction and different horizontal raster directions (e.g., TopLeft→BottomRight+TopRight→BottomRight; or BottomLeft→TopRight+BottomRight→TopLeft). In certain embodiments, the raster scans in the pair may be in any order (e.g., TL→BR first or TR→BL first) (e.g., TopLeft→BottomRight+TopRight→BottomRight; BottomLeft→TopRight+BottomRight→TopLeft or BottomLeft→TopRight+BottomRight→TopLeft; TopLeft→BottomRight+TopRight→BottomRight).

In certain embodiments, the one or more median filters 204A, 204B, and 204C may be applied to four optical flow inputs or two optical flow inputs. In some embodiments, the one or more median filters 204A, 204B, and 204C may be applied independently to the X and Y coordinate components of the optical flow. In certain embodiments, the one or more median filters 204A, 204B, and 204C may also include a smoothing filter 210, such as a finite input response (FIR), an FIR based gradient smoothing filter, or other similar smoothing filter 210 that may be applied independently to the X and Y coordinate components of the optical flow 206. For example, the smoothing filter 210 flattens regions of the optical flow 206. In certain embodiments, the one or more median filters 204A, 204B, and 204C may include a geometric median filter 212, which may be utilized to remove outliers and filter the optical flow along edges. In some embodiments, a 1D Warp ordering filter may be applied independently to the X and Y components of the optical flow 206. For example, the geometric median filter may ensure the absence of any folds in the warp field based on the optical flow 206. In one embodiment, the accelerated and efficient PatchMatch algorithm may search for non-monotonic warp field intervals and “cuts out” non-monotonic areas.

In certain embodiments, the optical flow computation architecture 200A, 200B may also perform an optical flow scaling 214. For example, the optical flow scaling 214 may be utilized to scale spatially and/or scale in amplitude. In certain embodiments, the optical flow scaling 214 (e.g., spatial or in amplitude) may be applied independently to the X and Y components of the optical flow 206. In one embodiment, both spatial and amplitude optical flow scaling 214 may be utilized. Additionally, the optical flow scaling 214 may also be utilized to generate a dense optical flow 206. In certain embodiments, to evaluate the generated optical flow 206, the optical flow computation architecture 200A, 200B may compare the optical flow 206 against a reference optical flow, and generate a confidence metric based on the comparison of the generated optical flow 206 and the reference optical flow expected by consistent with the generated optical flow 206.

For example, in one embodiment, the confidence metric may include a measure of a consistency between the generated optical flow 206 and the reference optical flow. In one embodiment, the measure of consistency may be forward and backward optical flows between successive image frames sequential in time, as well as consistent left to right and right to left. In one embodiment, the confidence metric may include an N-bit confidence metric generated per vector to measure the consistency between the generated optical flow 206 and the reference optical flow (e.g., a quality of the generated optical flow 206). In this way, the present techniques for accelerating and efficiently generating optical flow computations for a number of successive image frames by providing an accelerated and efficient PatchMatch algorithm may reduce the memory resources, processing resources, and the processing times of computing devices (e.g., the HMD 110, the computing system 108, and/or the computing system 120) otherwise suitable for executing PatchMatch algorithms and computing optical flow.

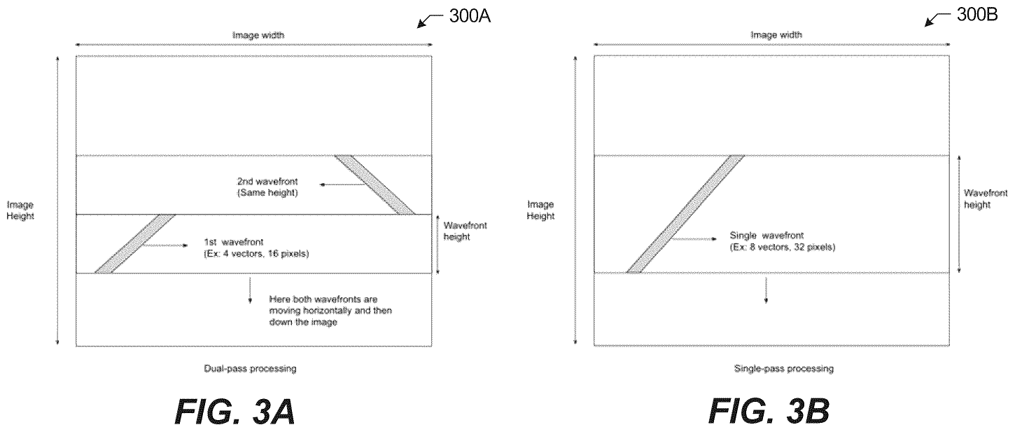

FIGS. 3A and 3B illustrate example embodiments of a single raster scan diagram 300A and a dual raster scan diagram 300B, respectively, in accordance with the presently disclosed embodiments. As depicted by the single raster scan diagram 300A and the dual raster scan diagram 300B, respectively, the accelerated and efficient PatchMatch algorithm as disclosed herein may include as part of the initialization process two raster scans (e.g., in the same vertical scan direction, but opposite horizontal directions) concurrently so as to both minimize the neighborhood consensus with respect to, for example greyscale or black-white image frames.

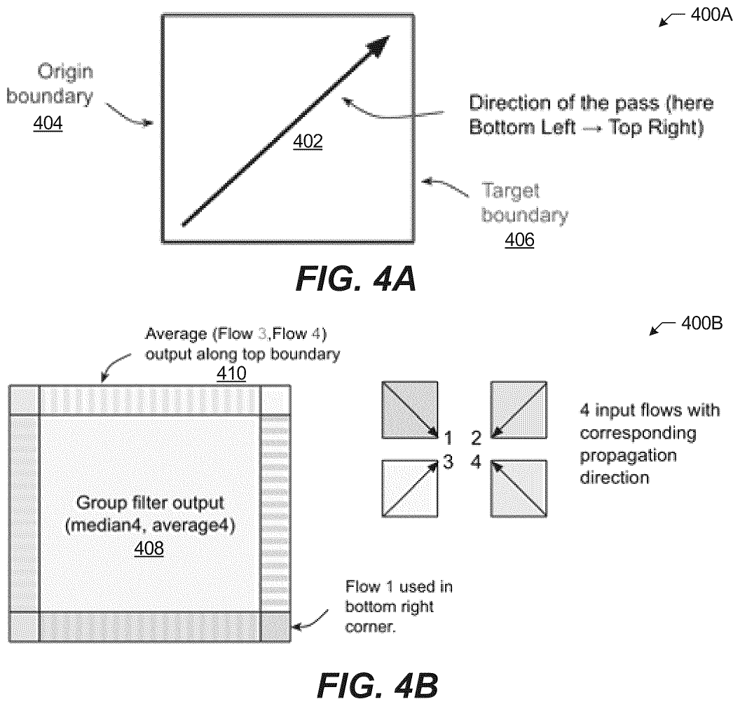

FIGS. 4A and 4B illustrate example embodiments of a margin filtering around boundaries diagram 400A and a marginal filtering including four-input flow group filter diagram 400B, respectively, in accordance with the presently disclosed embodiments. For example, as depicted by the margin filtering around boundaries diagram 400A, for a given raster scan direction 402, the optical flow around the origin boundaries 404, for example, may be less reliable than the optical flow around the target boundaries 406, for example. In certain embodiments, the optical flow around the target boundaries 406 may benefit from the propagation of the optical flow within the patch. As further depicted by the marginal filtering including four-input flow group filter diagram 400B, configurable margins (e.g., horizontal and vertical margins) may be provided to filter out optical flows around their origin boundaries, such that when chaining raster scans, each raster scan may be filtered in such a manner that along the original boundaries the output flow is replaced by the input flow. In another example, when utilizing an optical flow group filter 408, along a given boundary 410, only the optical flows for which that boundary is a target boundary may be utilized as illustrated.

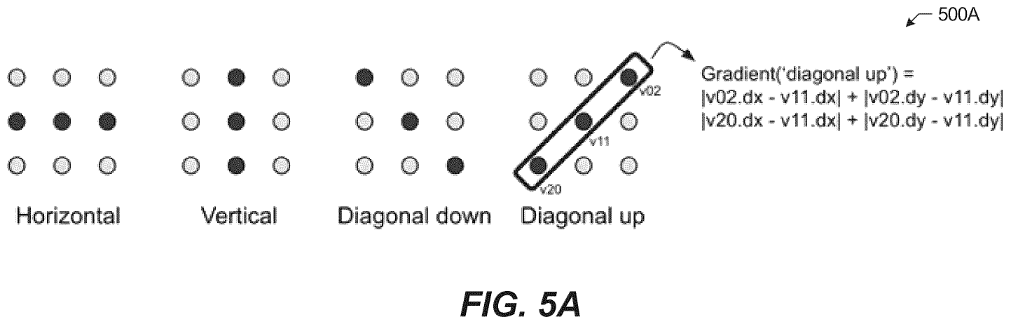

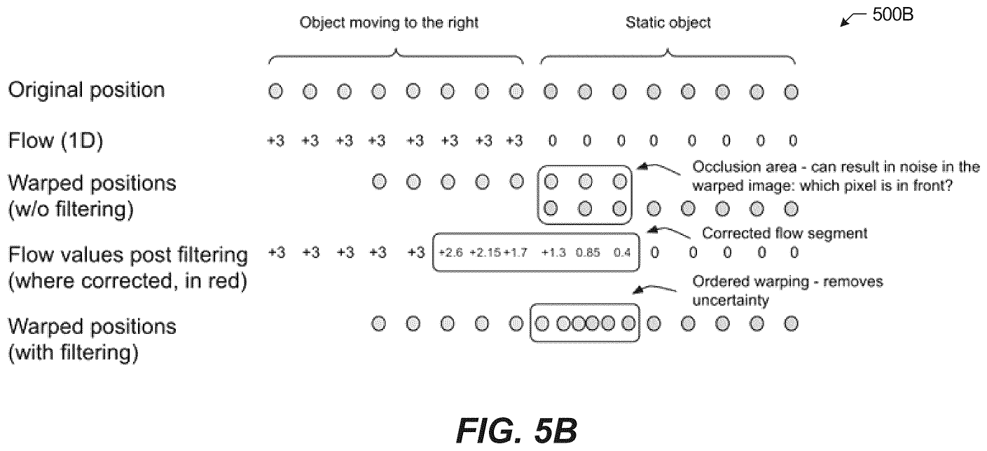

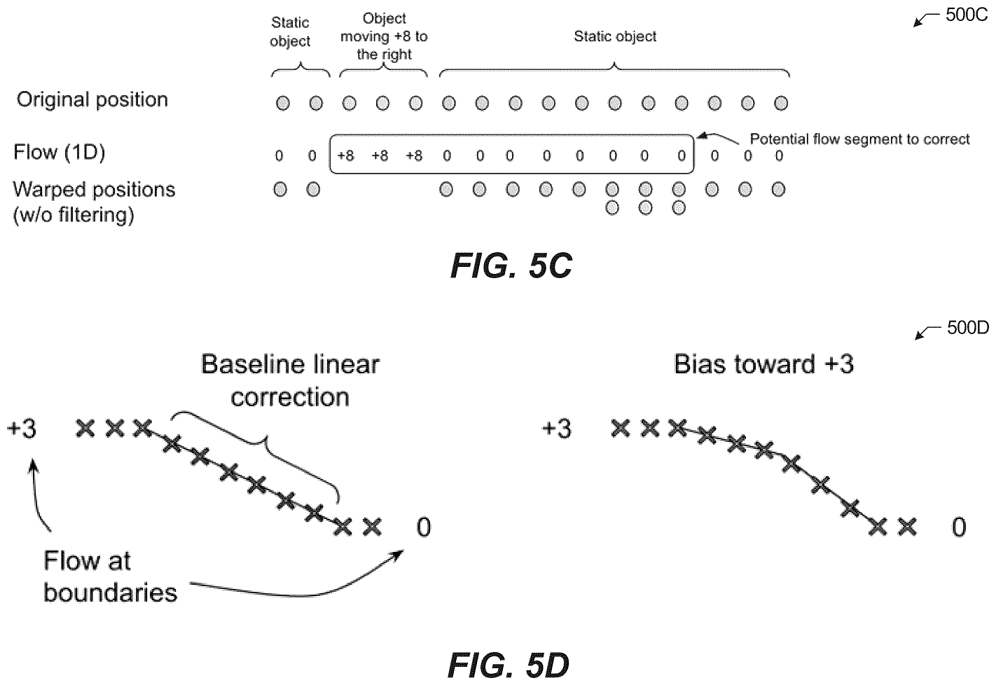

FIGS. 5A-5D illustrate example embodiments of a median smoothing filtering diagram 500A, a warp ordering filtering diagram 500B, another warp ordering filtering diagram 500C, and a warp ordering filtering correction diagram 500D, respectively, in accordance with the presently disclosed embodiments. As depicted by the median smoothing filtering diagram 500A, the filter utilizes, for example, a 3×3 window and may be geometric. In one embodiment, the LI norm may be utilized to calculate the distance between 2 vectors: dist(v1,v2)=|v1.dx−v2.dx|+|v1.dy−v2.dy|. In certain embodiments, for each vector within the window, a metric may be computed as the sum of the distances (SAD) of that vector to the other N vectors within the window. In one embodiment, within the sum, the distance to the center vector may be weighted, such that the minimum weight is 1.0 and a larger weight reduces the filter strength. In another embodiment, the vector with the smallest metric may be selected. The center vector weight may be the sum of a fixed programmable weight and a variable weight, which may be increased where low flow gradient across the center vector is detected in any of four raster scan directions (e.g., horizontal, vertical, diagonal down, diagonal down). In one embodiment, the minimum gradient may be utilized to define an adaptive weight, which may be added to the fixed weight.

In certain embodiments, as depicted by the warp ordering filtering diagram 500B, the warp ordering filtering diagram 500C, and the warp ordering filtering correction diagram 500D, the filter may include a ID filter and operates on the flow component associated with the dimension, in which dX is filtered horizontally and dY is filtered vertically. In certain embodiments, the filter detects 1D segments in the flow that may result in potential occlusion and smooths flow transitions in each dimension to avoid warping artifacts. In one embodiment, the smoothing may be performed by interpolating linearly the optical flow between the boundaries of the segment. In one embodiment, the filter strength may be controlled through registers. For example, the filter strength may be controlled by scaling optical flows and/or damping the optical flows. In certain embodiments, the linear interpolation utilized for the correction may be biased toward the largest motion. For example, by biasing toward the largest motion, any blunting effect of the filter on the leading edge may be reduced.

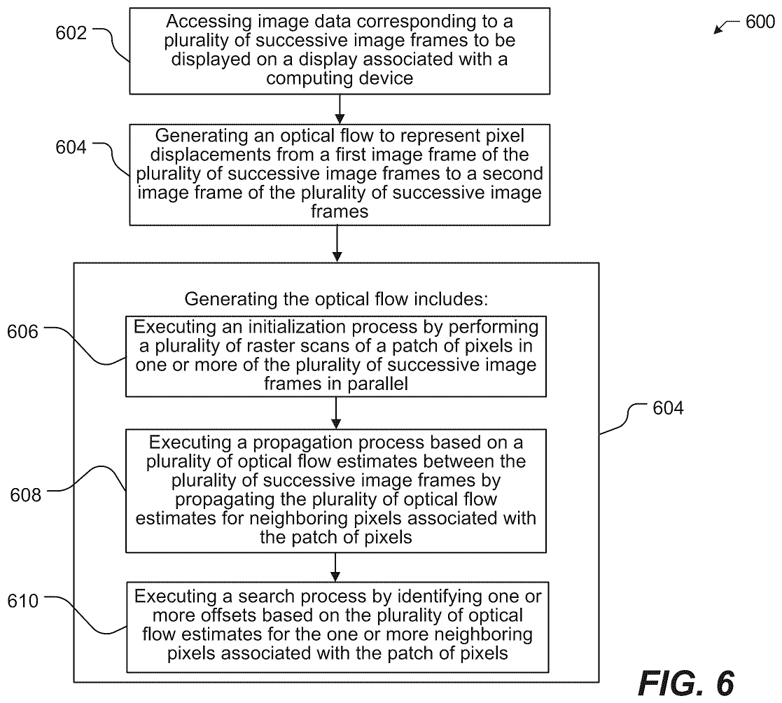

FIG. 6 illustrates is a flow diagram of a method 600 for accelerating and efficiently generating optical flow computations for a number of successive image frames, in accordance with the presently disclosed embodiments. The method 600 may be performed utilizing one or more processors that may include hardware (e.g., a general purpose processor, a graphic processing units (GPU), an application-specific integrated circuit (ASIC), a system-on-chip (SoC), a microcontroller, a field-programmable gate array (FPGA), or any other processing device(s) that may be suitable for processing image data), software (e.g., instructions running/executing on one or more processors), firmware (e.g., microcode), or any combination thereof.

The method 600 may begin at block 602 with one or more processors accessing image data corresponding to a plurality of successive image frames to be displayed on a display associated with a computing device. For example, in certain embodiments, the one or more processors may access the image data corresponding to the plurality of successive image frames comprises accessing one or more 2D arrays of pixels corresponding to the plurality of successive image frames. The method 600 may then continue at block 604 with the one or more processors generating an optical flow to represent pixel displacements from a first image frame of the plurality of successive image frames to a second image frame of the plurality of successive image frames.

In certain embodiments, generating the optical flow at block 604 may include the method 600 continuing at block 606 with the one or more processors executing an initialization process by performing a plurality of raster scans of a patch of pixels in one or more of the plurality of successive image frames in parallel. For example, in one embodiment, the plurality of raster scans of the patch of pixels may include a plurality of optical flow estimates between the plurality of successive image frames. In certain embodiments, the generating the optical flow at block 604 may include the method 600 continuing at block 608 with the one or more processors executing a propagation process based on the plurality of optical flow estimates between the plurality of successive image frames.

For example, in one embodiment, the one or more processors may execute the propagation process by propagating the plurality of optical flow estimates for one or more neighboring pixels associated with the patch of pixels. In certain embodiments, the generating the optical flow at block 604 may include the method 600 concluding at block 610 with the one or more processors executing a search process by identifying one or more offsets based at least in part on the plurality of optical flow estimates for the one or more neighboring pixels associated with the patch of pixels.

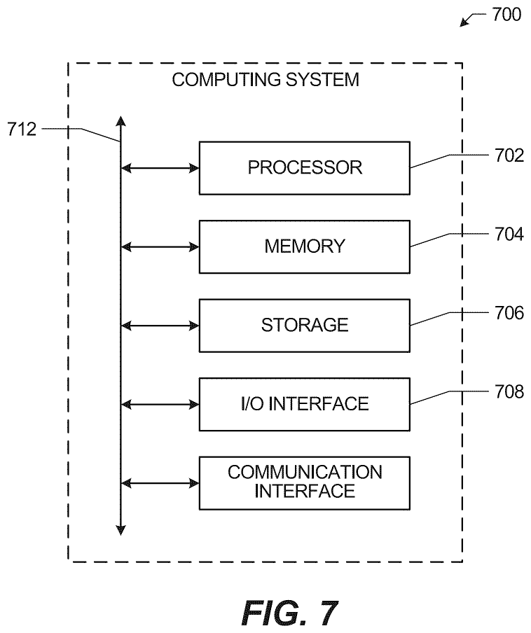

FIG. 7 illustrates an example computer system 700 that may be useful in performing one or more of the foregoing techniques as presently disclosed herein. In certain embodiments, one or more computer systems 700 perform one or more steps of one or more methods described or illustrated herein. In certain embodiments, one or more computer systems 700 provide functionality described or illustrated herein. In certain embodiments, software running on one or more computer systems 700 performs one or more steps of one or more methods described or illustrated herein or provides functionality described or illustrated herein. Certain embodiments include one or more portions of one or more computer systems 700. Herein, reference to a computer system may encompass a computing device, and vice versa, where appropriate. Moreover, reference to a computer system may encompass one or more computer systems, where appropriate.

This disclosure contemplates any suitable number of computer systems 700. This disclosure contemplates computer system 700 taking any suitable physical form. As example and not by way of limitation, computer system 700 may be an embedded computer system, a system-on-chip (SOC), a single-board computer system (SBC) (such as, for example, a computer-on-module (COM) or system-on-module (SOM)), a desktop computer system, a laptop or notebook computer system, an interactive kiosk, a mainframe, a mesh of computer systems, a mobile telephone, a personal digital assistant (PDA), a server, a tablet computer system, an augmented/virtual reality device, or a combination of two or more of these. Where appropriate, computer system 700 may include one or more computer systems 700; be unitary or distributed; span multiple locations; span multiple machines; span multiple data centers; or reside in a cloud, which may include one or more cloud components in one or more networks. Where appropriate, one or more computer systems 700 may perform without substantial spatial or temporal limitation one or more steps of one or more methods described or illustrated herein.

As an example, and not by way of limitation, one or more computer systems 700 may perform in real time or in batch mode one or more steps of one or more methods described or illustrated herein. One or more computer systems 700 may perform at different times or at different locations one or more steps of one or more methods described or illustrated herein, where appropriate. In certain embodiments, computer system 700 includes a processor 702, memory 704, storage 706, an input/output (I/O) interface 708, a communication interface 710, and a bus 712. Although this disclosure describes and illustrates a particular computer system having a particular number of particular components in a particular arrangement, this disclosure contemplates any suitable computer system having any suitable number of any suitable components in any suitable arrangement.

In certain embodiments, processor 702 includes hardware for executing instructions, such as those making up a computer program. As an example, and not by way of limitation, to execute instructions, processor 702 may retrieve (or fetch) the instructions from an internal register, an internal cache, memory 704, or storage 706; decode and execute them; and then write one or more results to an internal register, an internal cache, memory 704, or storage 706. In certain embodiments, processor 702 may include one or more internal caches for data, instructions, or addresses. This disclosure contemplates processor 702 including any suitable number of any suitable internal caches, where appropriate. As an example, and not by way of limitation, processor 702 may include one or more instruction caches, one or more data caches, and one or more translation lookaside buffers (TLBs). Instructions in the instruction caches may be copies of instructions in memory 704 or storage 706, and the instruction caches may speed up retrieval of those instructions by processor 702.

Data in the data caches may be copies of data in memory 704 or storage 706 for instructions executing at processor 702 to operate on; the results of previous instructions executed at processor 702 for access by subsequent instructions executing at processor 702 or for writing to memory 704 or storage 706; or other suitable data. The data caches may speed up read or write operations by processor 702. The TLBs may speed up virtual-address translation for processor 702. In certain embodiments, processor 702 may include one or more internal registers for data, instructions, or addresses. This disclosure contemplates processor 702 including any suitable number of any suitable internal registers, where appropriate. Where appropriate, processor 702 may include one or more arithmetic logic units (ALUs); be a multi-core processor; or include one or more processors 702. Although this disclosure describes and illustrates a particular processor, this disclosure contemplates any suitable processor.

In certain embodiments, memory 704 includes main memory for storing instructions for processor 702 to execute or data for processor 702 to operate on. As an example, and not by way of limitation, computer system 700 may load instructions from storage 706 or another source (such as, for example, another computer system 700) to memory 704. Processor 702 may then load the instructions from memory 704 to an internal register or internal cache. To execute the instructions, processor 702 may retrieve the instructions from the internal register or internal cache and decode them. During or after execution of the instructions, processor 702 may write one or more results (which may be intermediate or final results) to the internal register or internal cache. Processor 702 may then write one or more of those results to memory 704. In certain embodiments, processor 702 executes only instructions in one or more internal registers or internal caches or in memory 704 (as opposed to storage 706 or elsewhere) and operates only on data in one or more internal registers or internal caches or in memory 704 (as opposed to storage 706 or elsewhere).

One or more memory buses (which may each include an address bus and a data bus) may couple processor 702 to memory 704. Bus 712 may include one or more memory buses, as described below. In certain embodiments, one or more memory management units (MMUs) reside between processor 702 and memory 704 and facilitate accesses to memory 704 requested by processor 702. In certain embodiments, memory 704 includes random access memory (RAM). This RAM may be volatile memory, where appropriate. Where appropriate, this RAM may be dynamic RAM (DRAM) or static RAM (SRAM). Moreover, where appropriate, this RAM may be single-ported or multi-ported RAM. This disclosure contemplates any suitable RAM. Memory 704 may include one or more memories 704, where appropriate. Although this disclosure describes and illustrates particular memory, this disclosure contemplates any suitable memory.

In certain embodiments, storage 706 includes mass storage for data or instructions. As an example, and not by way of limitation, storage 706 may include a hard disk drive (HDD), a floppy disk drive, flash memory, an optical disc, a magneto-optical disc, magnetic tape, or a Universal Serial Bus (USB) drive or a combination of two or more of these. Storage 706 may include removable or non-removable (or fixed) media, where appropriate. Storage 706 may be internal or external to computer system 700, where appropriate. In certain embodiments, storage 706 is non-volatile, solid-state memory. In certain embodiments, storage 706 includes read-only memory (ROM). Where appropriate, this ROM may be mask-programmed ROM, programmable ROM (PROM), erasable PROM (EPROM), electrically erasable PROM (EEPROM), electrically alterable ROM (EAROM), or flash memory or a combination of two or more of these. This disclosure contemplates mass storage 706 taking any suitable physical form. Storage 706 may include one or more storage control units facilitating communication between processor 702 and storage 706, where appropriate. Where appropriate, storage 706 may include one or more storages 706. Although this disclosure describes and illustrates particular storage, this disclosure contemplates any suitable storage.

In certain embodiments, I/O interface 708 includes hardware, software, or both, providing one or more interfaces for communication between computer system 700 and one or more I/O devices. Computer system 700 may include one or more of these I/O devices, where appropriate. One or more of these I/O devices may enable communication between a person and computer system 700. As an example, and not by way of limitation, an I/O device may include a keyboard, keypad, microphone, monitor, mouse, printer, scanner, speaker, still camera, stylus, tablet, touch screen, trackball, video camera, another suitable I/O device or a combination of two or more of these. An I/O device may include one or more sensors. This disclosure contemplates any suitable I/O devices and any suitable I/O interfaces 708 for them. Where appropriate, I/O interface 708 may include one or more device or software drivers enabling processor 702 to drive one or more of these I/O devices. I/O interface 708 may include one or more I/O interfaces 708, where appropriate. Although this disclosure describes and illustrates a particular I/O interface, this disclosure contemplates any suitable I/O interface.

In certain embodiments, communication interface 710 includes hardware, software, or both providing one or more interfaces for communication (such as, for example, packet-based communication) between computer system 700 and one or more other computer systems 700 or one or more networks. As an example, and not by way of limitation, communication interface 710 may include a network interface controller (NIC) or network adapter for communicating with an Ethernet or other wire-based network or a wireless NIC (WNIC) or wireless adapter for communicating with a wireless network, such as a WI-FI network. This disclosure contemplates any suitable network and any suitable communication interface 710 for it.

As an example, and not by way of limitation, computer system 700 may communicate with an ad hoc network, a personal area network (PAN), a local area network (LAN), a wide area network (WAN), a metropolitan area network (MAN), or one or more portions of the Internet or a combination of two or more of these. One or more portions of one or more of these networks may be wired or wireless. As an example, computer system 700 may communicate with a wireless PAN (WPAN) (such as, for example, a BLUETOOTH WPAN), a WI-FI network, a WI-MAX network, a cellular telephone network (such as, for example, a Global System for Mobile Communications (GSM) network), or other suitable wireless network or a combination of two or more of these. Computer system 700 may include any suitable communication interface 710 for any of these networks, where appropriate. Communication interface 710 may include one or more communication interfaces 710, where appropriate. Although this disclosure describes and illustrates a particular communication interface, this disclosure contemplates any suitable communication interface.

In certain embodiments, bus 712 includes hardware, software, or both coupling components of computer system 700 to each other. As an example and not by way of limitation, bus 712 may include an Accelerated Graphics Port (AGP) or other graphics bus, an Enhanced Industry Standard Architecture (EISA) bus, a front-side bus (FSB), a HYPERTRANSPORT (HT) interconnect, an Industry Standard Architecture (ISA) bus, an INFINIBAND interconnect, a low-pin-count (LPC) bus, a memory bus, a Micro Channel Architecture (MCA) bus, a Peripheral Component Interconnect (PCI) bus, a PCI-Express (PCIe) bus, a serial advanced technology attachment (SATA) bus, a Video Electronics Standards Association local (VLB) bus, or another suitable bus or a combination of two or more of these. Bus 712 may include one or more buses 712, where appropriate. Although this disclosure describes and illustrates a particular bus, this disclosure contemplates any suitable bus or interconnect.

Herein, a computer-readable non-transitory storage medium or media may include one or more semiconductor-based or other integrated circuits (ICs) (such, as for example, field-programmable gate arrays (FPGAs) or application-specific ICs (ASICs)), hard disk drives (HDDs), hybrid hard drives (HHDs), optical discs, optical disc drives (ODDs), magneto-optical discs, magneto-optical drives, floppy diskettes, floppy disk drives (FDDs), magnetic tapes, solid-state drives (SSDs), RAM-drives, SECURE DIGITAL cards or drives, any other suitable computer-readable non-transitory storage media, or any suitable combination of two or more of these, where appropriate. A computer-readable non-transitory storage medium may be volatile, non-volatile, or a combination of volatile and non-volatile, where appropriate.

Herein, “or” is inclusive and not exclusive, unless expressly indicated otherwise or indicated otherwise by context. Therefore, herein, “A or B” means “A, B, or both,” unless expressly indicated otherwise or indicated otherwise by context. Moreover, “and” is both joint and several, unless expressly indicated otherwise or indicated otherwise by context. Therefore, herein, “A and B” means “A and B, jointly or severally,” unless expressly indicated otherwise or indicated otherwise by context.

The scope of this disclosure encompasses all changes, substitutions, variations, alterations, and modifications to the example embodiments described or illustrated herein that a person having ordinary skill in the art would comprehend. The scope of this disclosure is not limited to the example embodiments described or illustrated herein. Moreover, although this disclosure describes and illustrates respective embodiments herein as including particular components, elements, feature, functions, operations, or steps, any of these embodiments may include any combination or permutation of any of the components, elements, features, functions, operations, or steps described or illustrated anywhere herein that a person having ordinary skill in the art would comprehend. Furthermore, reference in the appended claims to an apparatus or system or a component of an apparatus or system being adapted to, arranged to, capable of, configured to, enabled to, operable to, or operative to perform a particular function encompasses that apparatus, system, component, whether or not it or that particular function is activated, turned on, or unlocked, as long as that apparatus, system, or component is so adapted, arranged, capable, configured, enabled, operable, or operative. Additionally, although this disclosure describes or illustrates certain embodiments as providing particular advantages, certain embodiments may provide none, some, or all of these advantages.

What is claimed is:

1. A method for generating an optical flow for a plurality of successive image frames, comprising, by a computing device:
accessing image data corresponding to a plurality of successive image frames to be displayed on a display associated with a computing device; and
generating an optical flow to represent pixel displacements from a first image frame of the plurality of successive image frames to a second image frame of the plurality of successive image frames, wherein generating the optical flow for the plurality of successive image frames comprises:
executing an initialization process by performing a plurality of raster scans of a patch of pixels in one or more of the plurality of successive image frames in parallel, wherein the plurality of raster scans of the patch of pixels comprises a plurality of optical flow estimates between the plurality of successive image frames;
executing a propagation process based on the plurality of optical flow estimates between the plurality of successive image frames, wherein executing the propagation process comprises propagating the plurality of optical flow estimates for one or more neighboring pixels associated with the patch of pixels; and
executing a search process by identifying one or more offsets based at least in part on the plurality of optical flow estimates for the one or more neighboring pixels associated with the patch of pixels.

2. The method of claim 1, wherein accessing the image data corresponding to the plurality of successive image frames comprises accessing one or more two-dimensional (2D) arrays of pixels corresponding to the plurality of successive image frames.

3. The method of claim 1, wherein executing the propagation process comprises executing the propagation process based on the plurality of optical flow estimates and in accordance with one or more predetermined metrics.

4. The method of claim 3, wherein the one or more predetermined metrics comprises one or more of a data metric, a rigidity metric, or a constraint metric.

5. The method of claim 1, wherein performing the plurality of raster scans of the patch of pixels further comprises performing a plurality of raster scans in a same vertical raster scan direction or in different horizontal raster scan directions.

6. The method of claim 1, wherein generating the optical flow for the plurality of successive image frames further comprises performing a filtering and a scaling of the optical flow.

7. The method of claim 1, wherein generating the optical flow for the plurality of successive image frames further comprises:
comparing the generated optical flow to a reference optical flow; and
generating one or more confidence metrics based on the comparison of the generated optical flow and the reference optical flow, wherein the one or more confidence metrics comprises a measure of a consistency between the generated optical flow and the reference optical flow.

8. A computing device, comprising:
one or more non-transitory computer-readable storage media including instructions; and
one or more processors coupled to the storage media, the one or more processors configured to execute the instructions to:
access image data corresponding to a plurality of successive image frames to be displayed on a display associated with the computing device; and
generate an optical flow to represent pixel displacements from a first image frame of the plurality of successive image frames to a second image frame of the plurality of successive image frames, wherein generating the optical flow for the plurality of successive image frames comprises:
executing an initialization process by performing a plurality of raster scans of a patch of pixels in one or more of the plurality of successive image frames in parallel, wherein the plurality of raster scans of the patch of pixels comprises a plurality of optical flow estimates between the plurality of successive image frames;
executing a propagation process based on the plurality of optical flow estimates between the plurality of successive image frames, wherein executing the propagation process comprises propagating the plurality of optical flow estimates for one or more neighboring pixels associated with the patch of pixels; and
executing a search process by identifying one or more offsets based at least in part on the plurality of optical flow estimates for the one or more neighboring pixels associated with the patch of pixels.

9. The computing device of claim 8, wherein the instructions to access the image data corresponding to the plurality of successive image frames further comprise instructions to access one or more two-dimensional (2D) arrays of pixels corresponding to the plurality of successive image frames.

10. The computing device of claim 8, wherein the instructions to execute the propagation process further comprise instructions to execute the propagation process based on the plurality of optical flow estimates and in accordance with one or more predetermined metrics.

11. The computing device of claim 10, wherein the one or more predetermined metrics comprises one or more of a data metric, a rigidity metric, or a constraint metric.

12. The computing device of claim 8, wherein the instructions to perform the plurality of raster scans of the patch of pixels further comprise instructions to perform a plurality of raster scans in a same vertical raster scan direction or in different horizontal raster scan directions.

13. The computing device of claim 8, wherein the instructions to generate the optical flow for the plurality of successive image frames further comprise instructions to perform a filtering and a scaling of the optical flow.

14. The computing device of claim 8, wherein the instructions to generate the optical flow for the plurality of successive image frames further comprise instructions to:
compare the generated optical flow to a reference optical flow; and
generate one or more confidence metrics based on the comparison of the generated optical flow and the reference optical flow, wherein the one or more confidence metrics comprises a measure of a consistency between the generated optical flow and the reference optical flow.

15. A non-transitory computer-readable medium comprising instructions that, when executed by one or more processors of a computing device, cause the one or more processors to:
access image data corresponding to a plurality of successive image frames to be displayed on a display associated with the computing device; and
generate an optical flow to represent pixel displacements from a first image frame of the plurality of successive image frames to a second image frame of the plurality of successive image frames, wherein generating the optical flow for the plurality of successive image frames comprises:
executing an initialization process by performing a plurality of raster scans of a patch of pixels in one or more of the plurality of successive image frames in parallel, wherein the plurality of raster scans of the patch of pixels comprises a plurality of optical flow estimates between the plurality of successive image frames;
executing a propagation process based on the plurality of optical flow estimates between the plurality of successive image frames, wherein executing the propagation process comprises propagating the plurality of optical flow estimates for one or more neighboring pixels associated with the patch of pixels; and
executing a search process by identifying one or more offsets based at least in part on the plurality of optical flow estimates for the one or more neighboring pixels associated with the patch of pixels.

16. The non-transitory computer-readable medium of claim 15, wherein the instructions to access the image data corresponding to the plurality of successive image frames further comprise instructions to access one or more two-dimensional (2D) arrays of pixels corresponding to the plurality of successive image frames.

17. The non-transitory computer-readable medium of claim 15, wherein the instructions to execute the propagation process further comprise instructions to execute the propagation process based on the plurality of optical flow estimates and in accordance with one or more predetermined metrics.

18. The non-transitory computer-readable medium of claim 15, wherein the instructions to perform the plurality of raster scans of the patch of pixels further comprise instructions to perform a plurality of raster scans in a same vertical raster scan direction or in different horizontal raster scan directions.

19. The non-transitory computer-readable medium of claim 15, wherein the instructions to generate the optical flow for the plurality of successive image frames further comprise instructions to perform a filtering and a scaling of the optical flow.

20. The non-transitory computer-readable medium of claim 15, wherein the instructions to generate the optical flow for the plurality of successive image frames further comprise instructions to:
compare the generated optical flow to a reference optical flow; and
generate one or more confidence metrics based on the comparison of the generated optical flow and the reference optical flow, wherein the one or more confidence metrics comprises a measure of a consistency between the generated optical flow and the reference optical flow.
